(19) United States
(12) Patent Application Publication
(10) Pub. No.: US 2025/0168767 A1
(43) Pub. Date: May 22, 2025

(54) ADMISSION CONTROL CONSIDERING NETWORK ENERGY SAVING

(71) Applicant: Lenovo (Singapore) Pte. Limited, Singapore (SG)

(72) Inventors: Tapisha Soni, Munich (DE); Karthikeyan Ganesan, Kronberg Im Taunus (DE); Ravi Kuchibhotla, Chicago, IL (US)

(73) Assignee: Lenovo (Singapore) Pte. Limited, Singapore (SG)

(21) Appl. No.: 18/951,369

(22) Filed: Nov. 18, 2024

Related U.S. Application Data
(60) Provisional application No. 63/600,711, filed on Nov. 19, 2023.

(51) Int. Cl. H04W 52/02; H04W 28/02; H04W 48/08

(52) U.S. Cl. CPC H04W 52/0212; H04W 28/0268; H04W 48/08

(57) ABSTRACT

Various aspects of the present disclosure relate to admission control considering network energy saving (NES). A network equipment (NE) configures the NE in an NES mode based on an NES class and NES configuration. The NES class and the NES configuration are obtained by the NES class and the NES configuration being determined at the NE, the NES class and the NES configuration are provisioned by a network management entity, the NES class is provisioned by the network management entity and the NES configuration is determined at the NE based on the NES class, and/or the NES class and the NES configuration are received from a network entity. A user equipment (UE) receives an indication of the NES class, where the NES class includes a QoS class identifier (QCI) supported by the NE, and configures the UE based on the NES configuration and/or the NES class.

### RELATED APPLICATION

This application claims priority to U.S. Provisional Application Ser. No. 63/600,711 filed Nov. 19, 2023 entitled “Admission Control Considering Network Energy Saving,” the disclosure of which is incorporated by reference herein in its entirety.

### TECHNICAL FIELD

The present disclosure relates to wireless communications, and more specifically to network energy saving (NES) and connection admission control.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, emissions and energy consumption from different elements of the system adversely contribute to the climate, and the operating expenses to run telecommunication services are immense. The increasing use of mobile data traffic will only continue to increase, combined with the rising costs of spectrum, capital investment, and ongoing RAN maintenance and upgrades, energy-saving measures in network operations are needed.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive, from a network equipment (NE), an indication of an NES class, the NES class including a quality of service (QoS) class identifier (QCI) supported by the NE, the indication of the NES class being signaled as at least one of: a system information broadcast (SIB) that includes an NES configuration of the NES class, or as a radio resource control (RRC) signaling that includes the NES configuration; or the SIB that indicates the NES class and a network capability information as the RRC signaling that includes the NES configuration. The UE configures the UE based on at least one of the NES configuration or the NES class.

In some implementations of the method and apparatuses described herein, an admission of a UE connection to the NE is based at least in part on an energy saving requirement associated with the NES class. An admission of a UE connection to the NE is based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

Some implementations of the method and apparatuses described herein may further include a processor for wireless communication to receive, from a NE, an indication of an NES class, the NES class including a QCI supported by the NE, the indication of the NES class being signaled as at least one of: a SIB that includes an NES configuration of the NES class, or as a RRC signaling that includes the NES configuration; or the SIB that indicates the NES class and a network capability information as the RRC signaling that includes the NES configuration. The processor configures a UE based on at least one of the NES configuration or the NES class.

In some implementations of the method and apparatuses described herein, an admission of a UE connection to the NE is based at least in part on an energy saving requirement associated with the NES class. An admission of a UE connection to the NE is based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

Some implementations of the method and apparatuses described herein may further include a method performed by a UE, the method including: receiving, from a NE, an indication of an NES class, the NES class including a QCI supported by the NE, the indication of the NES class being signaled as at least one of: a SIB that includes an NES configuration of the NES class, or as a RRC signaling that includes the NES configuration; or the SIB that indicates the NES class and a network capability information as the RRC signaling that includes the NES configuration. The method further including configuring the UE based on at least one of the NES configuration or the NES class.

In some implementations of the method and apparatuses described herein, the method further including an admission of a UE connection to the NE is based at least in part on an energy saving requirement associated with the NES class. An admission of a UE connection to the NE is based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

Some implementations of the method and apparatuses described herein may further include an NE for wireless communication to configure the NE in at least one NES mode based on an NES class and an NES configuration, the NES class and the NES configuration obtained by at least one of: determine the NES class and the NES configuration at the NE; the NES class and the NES configuration are provisioned by a network management entity; the NES class is provisioned by the network management entity and determine the NES configuration at the NE based at least in part on the NES class; or receive the NES class and the NES configuration from a network entity.

In some implementations of the method and apparatuses described herein, the network management entity is core network or an orchestration management entity that provisions at least one of the NES class or the NES configuration. The NE determines the NES class and the NES configuration at the NE based at least in part on data traffic and a QCI. The NE determines the NES class and the NES configuration at the NE based at least in part on cell load, data traffic, and available QCIs from the data traffic. At least one of the NES class or the NES configuration is determined based at least in part on a set of QCI values in a 5G QCI table, the set of QCI values corresponding to NES solutions for energy savings. At least one of the NES class or the NES configuration is determined based at least in part on a set of QoS energy saving metrics in a 5G QCI table, the set of QoS energy saving metrics corresponding to NES solutions for energy savings. The NES mode is associated with one or more QoS data flows, and wherein an association indicates that the one or more QoS data flows are supported by the NES mode. An admission of a UE connection is based at least in part on an energy saving requirement associated with the NES class. An admission of a UE connection is based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

Some implementations of the method and apparatuses described herein may further include a method performed by an NE, the method including: configuring the NE in at least one NES mode based on an NES class and an NES configuration, the NES class and the NES configuration obtained by at least one of: determining the NES class and the NES configuration at the NE; receiving the NES class and the NES configuration as provisioned by a network management entity; determining the NES configuration at the NE based at least in part on receiving the NES class as provisioned by the network management entity; or receiving the NES class and the NES configuration from a network entity.

In some implementations of the method and apparatuses described herein, the network management entity is core network or an orchestration management entity that provisions at least one of the NES class or the NES configuration. The NE determining the NES class and the NES configuration at the NE based at least in part on data traffic and a QCI. The NE determining the NES class and the NES configuration at the NE based at least in part on cell load, data traffic, and available QCIs from the data traffic. At least one of the NES class or the NES configuration is determined based at least in part on a set of QCI values in a 5G QCI table, the set of QCI values corresponding to NES solutions for energy savings. At least one of the NES class or the NES configuration is determined based at least in part on a set of QoS energy saving metrics in a 5G QCI table, the set of QoS energy saving metrics corresponding to NES solutions for energy savings. The NES mode is associated with one or more QoS data flows, and wherein an association indicates that the one or more QoS data flows are supported by the NES mode. An admission of a UE connection based at least in part on an energy saving requirement associated with the NES class. An admission of a UE connection based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

### BRIEF DESCRIPTION OF THE DRAWINGS

FIG. 1 illustrates an example of a wireless communications system in accordance with aspects of the present disclosure.

FIG. 2 illustrates an example of an NES-QoS framework, in accordance with aspects of the present disclosure.

FIG. 3 illustrates an example procedure for signaling of NES class, in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a network equipment (NE) in accordance with aspects of the present disclosure.

FIG. 7 illustrates a flowchart of a method performed by a UE in accordance with aspects of the present disclosure.

FIG. 8 illustrates a flowchart of a method performed by a NE in accordance with aspects of the present disclosure.

### DETAILED DESCRIPTION

A wireless communications system includes a great many number of components, devices, services, and equipment, many of which contribute to rising network costs and operational expenses. Additionally, the emissions and energy consumption from the many different network elements adversely contribute to the climate. The increasing use of mobile data traffic will only continue to increase, combined with the rising costs of spectrum, capital investment, and ongoing RAN maintenance and upgrades, energy-saving measures in network operations are needed. In particular, new communications use cases and the adoption of mm-Wave will require more sites and antennas. Although this lends to the prospect of a more efficient network, the result will be an increase in emissions without active intervention. As 5G becomes pervasive across industries and geographical areas, handling more advanced services and applications requiring very high data rates, networks are becoming denser, using more antennas, larger bandwidths, and more frequency bands. Implementations of NES can help to control the environmental impact of expanding 5G.

In a wireless communications system, most of the energy consumption is due to the radio access network and in particular, from the active antenna unit (AAU), with data centers and fiber transport accounting for a smaller share of the energy consumption. The power consumption of radio access can be split into two parts, a dynamic part that only consumes power when data transmission and/or reception is ongoing, and a static part during which power is consumed all of the time to maintain the necessary operation of the radio access devices, even when the data transmission and/or reception is not on-going. Power savings techniques are therefore needed, particularly with reference to base stations, for NES and to achieve more efficient operation dynamically and/or semi-statically, with a finer granularity adaptation of transmissions and/or receptions in one or more network energy saving techniques in time, frequency, spatial, and power domains, as well as support and feedback from UEs, potential UE assistance information, and an information exchange and coordination over network interfaces. Any potential network energy consumption gains also need to take into account the impact on network and UE performance by looking at key performance indicators (KPIs) such as spectral efficiency, capacity, user perceived throughput (UPT), latency, UE power consumption, complexity, handover performance, call drop rate, initial access performance, service level agreements (SLA) assurance related KPIs, etc.

Standardized NES capability can improve energy savings, as well as importantly serve the UEs without compromising performance. The diverse use cases from industry verticals lead to different traffic models and service QoS. It may be essential to conserve maximum network energy while fulfilling the stringent QoS requirements of these diverse service categories. Additionally, the traffic pattern can be expected to change with the type of use case and/or network scenario. Therefore, a tradeoff in energy savings and the demanded KPIs is likely to occur, such as for example, a cell benefiting from maximum energy saving cannot satisfy latency-critical service requirements of sub-millisecond end-to-end latency for multiple UEs. Such degradation in QoS is intolerable for use cases like augmented reality and/or virtual reality (AR/VR), haptic feedback, autonomous vehicles, mission-critical communication, mobile robots, etc. Hence, an adaptive and robust NES mechanism is implemented to attain an optimal balance.

Conventionally, network energy savings solutions do not integrate QoS awareness and lack flexibility. The network configures the NES mode independent of any QoS-relevant or energy saving inputs from other entities, such as the customers (e.g., UEs), operators, or verticals. Additionally, the admission control procedure is performed with no consideration of the energy saving solution configured in a cell. This can lead to either user performance degradation and thus service interruption or inefficient energy saving solutions. Further, existing studies concentrate more on how to satisfy user experience, and attempt to achieve energy efficiency within the network at the same time, which leads to the requirements, use cases, and solutions all basically within the network itself. Verticals and customers have no approach for energy efficiency related information from the network.

Aspects of the disclosure are directed to techniques to mitigate the tradeoff in energy savings and UE performance by incorporating QoS awareness in energy saving mode. This disclosure introduces techniques for energy saving considering the requirements of the customers (e.g., UEs), operators, and/or verticals. The described techniques enable the network to determine a radio resource configuration based on the required energy saving and QoS, and further, provides a solution for admission control considering the network energy saving requirements and the NES mode configured in the cell. In solutions, a better negotiation can be achieved while fulfilling service requirements and saving the maximum possible energy. Further, aspects of the disclosure are directed to the mechanism of the NES class is created and signaled to mitigate the challenge arising from the tradeoff in energy savings and demanding KPIs. The NES class is defined as the identifier of the amount of energy saving or consumption, and incorporates QoS awareness in energy saving solutions. The NES class may be mapped to a QCI profile and an NES profile, which may include one or more NES configurations, energy saving, and/or QCIs. The NES class can be provided by a network entity or by O&M using SLAs, or may be generated by the gNB according to certain rules. The admission control is performed based on the supported NES class that also includes negotiation procedures.

In aspects of this disclosure, an NES class framework is created and signaling is defined, which may constitute the NES configuration as well as the attainable QoS when in NES mode. This disclosure also introduces provisioning of an NES class by the orchestration management (O&M) entity or core network to the gNB, or alternatively enabling the gNB to determine the NES class and the radio resource configuration by considering QoS flows and respective QCIs. Additionally, the legacy QoS framework is extended by integrating NES-relevant QoS metrics into the existing QCI table. It enables the network to determine the radio resource configuration based on the required energy saving and QoS, and further, provides a solution for admission control considering the network energy saving requirements and the NES mode configured in the cell. The proposed solution extends the legacy QoS framework with energy saving awareness and vice versa. Otherwise, a UE might experience radio link failures or performance degradation without any QoS awareness in energy saving solutions and vice versa. The network determines the NES configuration using cell load, traffic patterns, etc., however, this does not assure the user performance. The extensions proposed in this disclosure derive a robust solution and complement the legacy QoS/NES behavior. Additional aspects include signaling of the NES class and its association with QCI. Mapping of the NES class to each QoS flow by the orchestration management entity or core network provides the NES class to the gNB. Alternatively, the gNB generates the NES class based on the QCI, traffic patterns, and cell load, and thus decides the respective NES configuration for the corresponding NES class. Thus, admission control is performed based on the supported NES class that also includes negotiation procedures.

Aspects of the present disclosure are described in the context of a wireless communications system for admission control considering NES.

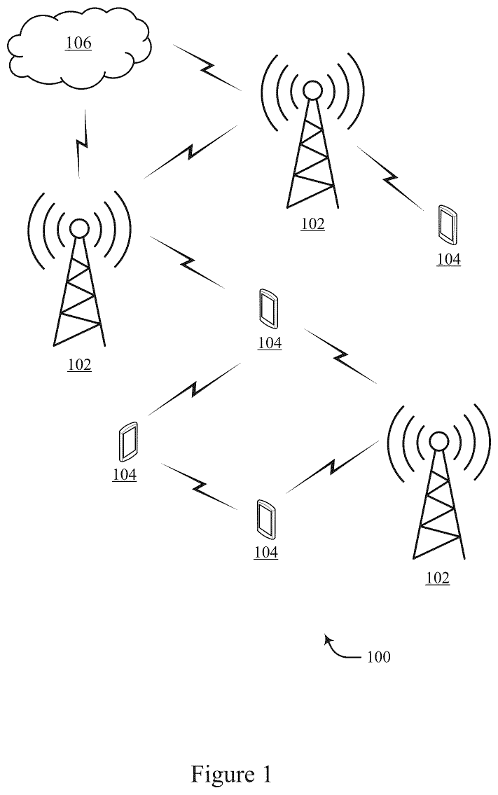

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station, gNB) configures the NE 102 in at least one NES mode based on an NES class and an NES configuration. In implementations, the NES class and the NES configuration are obtained by a determination of the NES class and the NES configuration at the NE; the NES class and the NES configuration is provisioned by a network management entity; the NES class is provisioned by the network management entity and a determination of the NES configuration at the NE based on the NES class; and/or the NES class and the NES configuration is received from a network entity. Further, a UE 104 receives, from an NE 102, an indication of an NES class, where the NES class includes a QCI supported by the NE. The indication of the NES class is signaled as an SIB that includes an NES configuration of the NES class, or as a RRC signaling that includes the NES configuration, and/or is signaled as the SIB that indicates the NES class and a network capability information as the RRC signaling that includes the NES configuration. The UE 104 also configures the UE based on the NES configuration or the NES class.

A technique to improve network energy savings in time domain is cell a discontinuous transmission and discontinuous reception (DTX/DRX), which is applicable to UEs in a RRC connected state. A periodic cell DTX/DRX (i.e., active, and non-active periods) can be configured by gNB via UE-specific RRC signaling per serving cell, and cell DTX/DRX can also be configured and operated together. At least the following parameters can be configured per cell DTX/DRX configuration, including periodicity, start slot/offset, and on duration. UE behavior is a focus when, at any point in time, the cell activates a single DTX/DRX configuration. It is up to network whether legacy UEs in an idle mode can access cells with cell DTX/DRX and the network should be able to allow NES-capable UEs to camp on the NES cell. The cell DTX/DRX mode can be activated or deactivated via dynamic L1/L2 signaling and UE-specific RRC signaling. Both UE specific and common L1/L2 signaling can be considered for activating and deactivating the cell DTX/DRX mode.

The main motivation behind standardizing NES capability is to improve the energy savings as well as to serve the users without compromising performance. The diverse use cases from industry verticals lead to different traffic models and service QoS. It is essential to conserve maximum network energy while fulfilling the stringent QoS requirements of these diverse service categories. Additionally, the traffic pattern can be expected to change with the type of use case and/or network scenario. Therefore, a tradeoff in energy savings and the demanded KPIs is likely to occur (e.g., a cell benefiting from maximum energy saving cannot satisfy latency-critical service requirements of sub-millisecond end-to-end latency for multiple UEs). Such degradation in QoS is intolerable for use cases like AR/VR, haptic feedback, autonomous vehicles, mission-critical communication, mobile robots, etc. Hence, an adaptive and robust NES mechanism is crucial to attain an optimal balance.

With reference to admission control considering NES, as described herein, the mechanism of an NES class can be implemented to mitigate the challenge arising from the tradeoff in energy savings and demanding KPIs. The NES class is defined as the identifier of the amount of energy saving or consumption, and incorporates QoS awareness in energy saving solutions. The NES class can be mapped to an NES profile which may contain NES configurations, a QoS profile, and/or a combination thereof. The NES class can be provided by the network entity or by an the orchestration management entity using SLAs or generated by the gNB according to certain rules. Admission control is performed based on the supported NES class that also includes negotiation procedures.

In implementations, the NES profile contains an NES configuration (i.e., the radio resource configuration and an energy cost metric used to represent energy saving or consumption). The NES configuration is the radio resource configuration required to support a certain NES class. For example, parameters can be configured per cell DTX/DRX configuration, such as the parameters including periodicity, start slot and offset, and the on-duration. The QoS profile represents a list of supported QCI values for the respective NES class. Alternatively, a single QCI can be associated with the NES class (e.g., the highest attainable QoS for the respective NES class). One NES class may be associated with one or more QCI values, and one NES class may be mapped to one or more radio resource configurations (NES configurations). The NES class definition can be extended with additional factors if they become relevant to the NES features.

The NES class can be implemented in one of several ways. In an implementation, each NES class is expressed as (and mainly consists of) an energy cost metric to represent energy saving and the respective QoS profile. An example is illustrated in Table1 below for the mapping of NES class to QCI. The NES profile does not provide information on what or how the network enables energy saving, while it only indicates what the network can achieve in terms of performance under configured and activated NES solutions or features. This is a conservative approach, in which the network does not need to reveal its active NES techniques and configurations. The details of NES mode configuration and techniques may be provided to the UE using alternative methods.

TABLE 1
Mapping of NES class to QCI

| NES class | NES Profile | QoS Profile |
|---|---|---|
| NES class | Energy cost | List of QCI |
| 0 | No NES mode is applicable | |
| 1 | Energy cost − 1 | QCI-x |
| | | QCI-y |
| | | QCI-z |
| | | . . . |
| 2 | Energy cost − 2 | QCI-a |
| | | QCI-b |
| | | . . . |
| 3 | Energy cost − 3 | QCI-m |
| . | . | . |
| . | . | . |
| . | . | . |
| N | Energy cost − N | . |

In another implementation of the NES class, the NES relevant configuration is also attached to the NES class and its respective guaranteed QoS is indicated by the list of supported QCIs. An example implementation is illustrated below in Table2. One or more NES techniques may be configured and activated by the network at the same time, thus, the corresponding NES configuration in the NES profile may provide all the NES relevant features that are supported, and the guaranteed QCIs are provided by the QoS profile of the NES class. The Table2 exemplifies the definition of NES class and describes a list of NES class, which is either pre-defined or configured dynamically. The NES class definition can be extended with additional factors if they become relevant to the NES features.

TABLE 2
NES class mapping to QoS profile

| NES class | NES Profile | | QoS Profile |
|---|---|---|---|
| NES class | NES configuration | Energy cost | Highest QCI |
| 0 | No NES mode is applicable | | |
| 1 | configuration − 1 | Energy cost − 1 | QCI-1 |
| | configuration − 2 | | |
| | . . . | | |
| 2 | configuration − 3 | Energy cost − 2 | QCI-2 |
| | . . . | | |
| 3 | configuration − 4 | Energy cost − 3 | QCI-3 |
| . | . . . | . | . |
| . | . . . | . | . |
| . | | . | . |
| N | configuration − N | Energy cost − N | . |

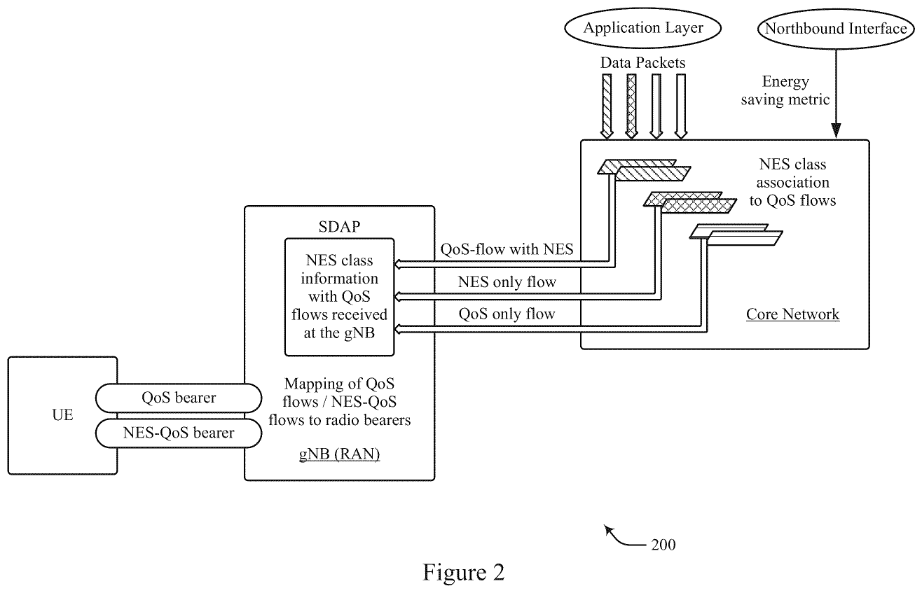

FIG. 2 illustrates an example of NES-QoS framework 200 in accordance with aspects of the present disclosure. In a first implementation, the NES-QoS framework and the methodology for provisioning or determining the NES class when energy-saving solutions are applied. The NES class as an energy saving identifier can encompass energy saving solutions to one or more QCIs. Alternatively, the NES class can incorporate QoS awareness into energy saving solutions. In a first alternative to determine which NES class can be supported, the determination of NES class is performed at the gNB. The QoS profile of a QoS flow is sent to the RAN that contains the QoS parameters. The gNB determines the radio resource configuration for NES using the existing mechanism. Taking into account the cell load, traffic pattern, QCIs, and the radio resource configuration for NES, the gNB determines the amount of energy that can be saved (i.e., power savings). Thus, the NES class is determined such that it can fulfill the QCIs, given a certain radio resource configuration. The NES class determined based on a quality of service flows that it can support.

With reference to determining the radio resource configuration for NES, the creation and association of an NES class with QCI is performed at a gNB. The QoS profile of a QoS flow is sent to the RAN that contains the QoS parameters. The gNB associates an appropriate NES profile to each QoS flow and generates the NES class. Alternatively, the gNB associates an appropriate NES profile to the highest received QCI generating a common NES class. In legacy, the gNB determines the NES configuration based on parameters, such as cell load, traffic pattern, etc., for instance, different thresholds of cell load are used for cell switch on/off. With the introduction of NES class, the gNB may additionally use the QoS profile and energy saving requirement to derive the NES configuration and/or profile that guarantees the QCI.

In a second alternative, the NES class is provisioned. In implementations, the energy metric may be provided by the northbound interface as part of service level agreements (SLAs), or directly as part of the subscription, which is translated and/or mapped to an NES class by a network entity (O&M or core network). The NES class is directly associated with the QoS flows such that each QoS flow is assigned the respective NES class. The illustration is shown in FIG. 2, in which different QoS flows are mapped to a specific NES class if energy awareness exists for the QoS flow. The NES class indication, along with QCI, is sent to the RAN or gNB, which may be used to determine the radio resource configuration for NES.

In a second implementation, a signaling mechanism for the NES class to and from the gNB (at NAS level) is described. The NES class may be provisioned from the network entity to the gNB which performs mapping of the NES flows to the NES radio bearer or the NES-QoS radio bearers. As shown in FIG. 2, the NES class may be signaled by extending the existing NES-flow framework. A set of predefined NES-QoS rules enable the mapping of QCI to an energy saving metric, which can be provisioned by the network entity. The network entity performs the binding of the NES flows to the NES-QoS rules based on the NES and service requirements. The NES class is assigned to the NES flow and it may be carried in an encapsulation header (i.e., without any changes to the end-to-end packet header). The granularity of marking the NES class from the core network can be implemented in at least two ways. In a first option, each NES flow may be associated with an appropriate NES class, similar to QCI association to NES flows. The NES flows can be legacy NES-only flows, NES flows with energy awareness, or NES-only flows with best effort NES. The NES flows that contain energy saving awareness are marked with NES class based on the NES-QoS rules. In a second option, one NES class is assigned to each PDU session containing multiple NES flows (for PDU session relevant parameters signaling). Data packets marked with the same NES class receive the same traffic forwarding treatment (for scheduling, admission threshold).

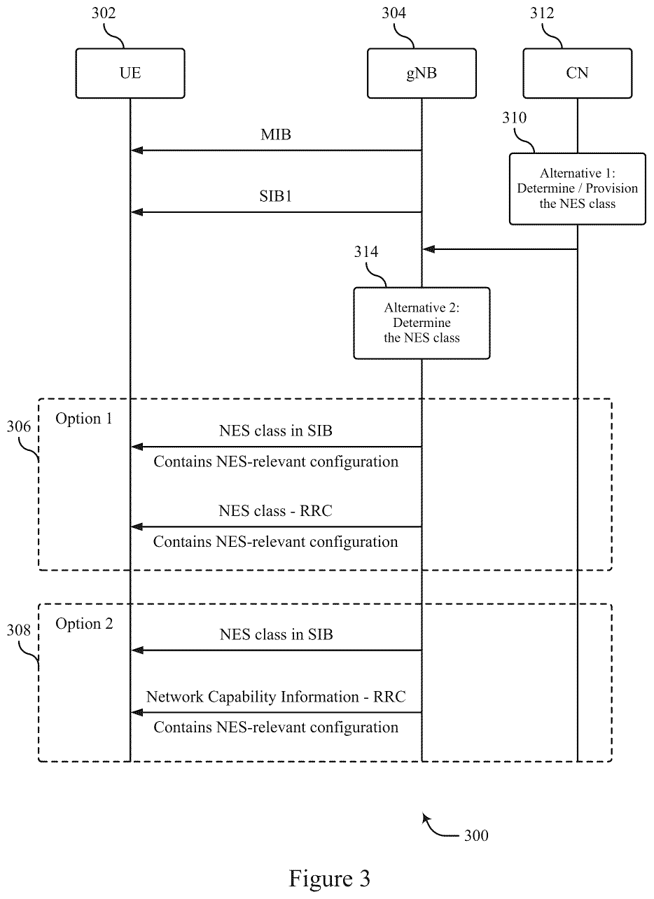

FIG. 3 illustrates an example procedure 300 for signaling of an NES class, in accordance with aspects of the present disclosure. In a third implementation, and with reference to signaling the NES class to a UE 302, the signaling of NES class is defined for different RRC states of the UE. The following options may be adapted to signal the NES class from a gNB 304. In a first option 306, the NES class contains the QCI supported by the gNB 304 for the configured energy saving solution. The determination of an NES class corresponding to the QCI and NES configuration can be determined at the gNB. This NES class is signaled using either the system information broadcast or dedicated RRC signaling depending on the RRC state of the UE. It can be broadcast using an SIB indication for UEs in connected, idle, and inactive states. Alternatively, the NES class can be signaled as a dedicated unicast for an RRC connected UE. The NES configuration can be contained in the NES class. As a second option 308, the NES class is signaled to indicate the QCI supported by the gNB for the configured energy saving solution, however, it does not include the NES configuration within the NES profile. The respective energy saving configuration can be additionally signaled as network capability information. Similar to UE capability information, the network capability information can be introduced as an RRC message sent from the gNB 304 to the UE 302. This informs the UE regarding all the supported features and configurations that may be relevant to energy saving solutions, such as the NES technique type, the NES configuration, bandwidth, etc.

In a fourth implementation, admission control determines which QoS flows will be supported. Admission or rejection of connection establishment, new service bearer establishment, handover, etc. may also depend on the NES relevant radio resource configuration and the capability of the cell in terms of energy saving (as an NES class). This ensures guaranteeing the required QoS and thus the SLA. If the required energy saving of an NES class is derived or obtained using either of the above described first alternative 310 at core network 312 or second alternative 314 at the gNB 304 of the first implementation is greater than or equal to the NES class configured in the cell, then the admission of the radio connection may be accepted. In this case, the cell may experience lower energy saving gains compared to the configured NES class, however, it does not lead to a reduction in user performance. If the energy saving of an NES class requirement is less than the NES class configured in the cell, one or more of the following negotiations, or the admission of the radio connection and QoS flows may be rejected, thereby avoiding degradation in performance.

A first option is described for NES priority, QoS negotiation. When energy saving is the priority, the QoS may be negotiated corresponding to the supported NES class. In an implementation, the RRC connection configuration and/or update can be used to provide a list of supported QCIs for the NES class and the UE may choose one of the QCI values, otherwise best effort QCI is provided. If accepted by the UE, the corresponding radio configuration can be provided. A second option is described for QoS and NES negotiation. When the QoS and energy saving are prioritized, there can be two alternatives: (a) QoS is negotiated first, and then the NES class is determined according to the negotiated QoS, otherwise best effort energy saving solution is provided; or (b) the NES class is negotiated first and then one of the QCIs for this NES class is negotiated. The UE can choose one of the NES class and the corresponding QCI with this negotiated procedure, otherwise, a best effort energy saving solution is provided. If accepted by the UE, then the corresponding radio configuration can be provided.

The network and the UE can choose a negotiation strategy considering the cell load, service, and energy saving requirements. For example, a low cell load and a high data rate, where the network energy saving solution x is configured. Alternatively, a high cell load and low downlink rate, where the network energy saving solution y is configured. Alternatively, a high cell load and a high downlink rate, where the energy saving solution z is configured.

In a fifth implementation, and as an alternative to the NES class, an extension of the legacy QoS framework (QCI tables) can be implemented. An extension of the legacy QoS framework (QCI tables) is shown and described. As an alternative to NES class, the legacy QoS framework (i.e., standardized QCI values mapped to QoS characteristics) can be extended for energy saving solutions. In a first option, the one-on-one mapping of the standardized QCI values to QoS characteristics may be extended by adding new QCI values for different energy saving solutions. The 5G QCI table shown in Table3 below is extended, with an additional set of QCI/5QI values (e.g., 101-105) designed particularly for NES solutions. In a second option, the one-on-one mapping of the standardized QCI values to QoS characteristics may be extended by adding additional QoS metrics for energy saving solutions, as shown in Table4 below. This is extended by including an NES-relevant QoS measure of energy saving in addition to the existing KPIs.

TABLE 3
Extend 5G QCI table with additional set of QCI/5QI values

| | | | | | Default | | |
|---|---|---|---|---|---|---|---|
| | | | | | Maximum | | |
| | | Default | Packet Delay | Packet | Data Burst | Default | |
| 5QI | Resource | Priority | Budget | Error | Volume | Averaging | |
| Value | Type | Level | (NOTE 3) | Rate | (NOTE 2) | Window | Example Services |
| 1 | GBR | 20 | 100 ms | 10⁻² | N/A | 2000 ms | Conversational Voice |
| | (NOTE 1) | | (NOTEs 11, 13) | | | | |
| 2 | | 40 | 150 ms | 10⁻³ | N/A | 2000 ms | Conversational Video |
| | | | (NOTEs 11, 13) | | | | (Live Streaming) |
| 3 | | 30 | 50 ms | 10⁻³ | N/A | 2000 ms | Real Time Gaming, V2X |
| | | | (NOTEs 11, 13) | | | | messages (see |
| | | | | | | | TS 23.287 [121]). |
| | | | | | | | Electricity distribution - |
| | | | | | | | medium voltage, Process |
| | | | | | | | automation monitoring |
| 4 | | 50 | 300 ms | 10⁻⁶ | N/A | 2000 ms | Non-Conversational |
| | | | (NOTEs 11, 13) | | | | Video (Buffered |
| | | | | | | | Streaming) |
| · | | . | . | . | . | . | . |
| · | | . | . | . | . | . | . |
| . | | . | . | . | . | . | . |
| 101 | GBR + | 20 | 100 ms | 10⁻² | N/A | 2000 ms | Conversational Voice |
| | NES | | (NOTEs 11, 13) | | | | |
| 102 | | 40 | 150 ms | 10⁻³ | N/A | 2000 ms | Conversational Video |
| | | | (NOTEs 11, 13) | | | | (Live Streaming) |
| 103 | | 30 | 50 ms | 10⁻³ | N/A | 2000 ms | Real Time Gaming, |
| | | | (NOTEs 11, 13) | | | | V2X messages (see |
| | | | | | | | TS 23.287 [121]). |
| | | | | | | | Electricity distribution - |
| | | | | | | | medium voltage, |
| | | | | | | | Process automation |
| | | | | | | | monitoring |
| 104 | | 50 | 300 ms | 10⁻⁶ | N/A | 2000 ms | Non-Conversational |
| | | | (NOTEs 11, 13) | | | | Video (Buffered |
| | | | | | | | Streaming) |
| 105 | | 7 | 75 ms | 10⁻² | N/A | 2000 ms | Mission Critical user |
| | | | (NOTEs 7, 8) | | | | plane Push To Talk |
| | | | | | | | voice (e.g. MCPTT) |
| . | | . | . | . | . | . | . |
| . | | . | . | . | . | . | . |
| . | | . | . | . | . | . | . |

TABLE 4
Extend 5G QCI table with NES-relevant QoS measure of energy saving

| | | | | | Default | | | |
|---|---|---|---|---|---|---|---|---|
| | | | Packet | | Maximum | | | |
| | | Default | Delay | Packet | Data Burst | Default | | |
| 5QI | Resource | Priority | Budget | Error | Volume | Averaging | | Energy |
| Value | Type | Level | (NOTE 3) | Rate | (NOTE 2) | Window | Example Services | Saving |
| 1 | GBR | 20 | 100 ms | 10⁻² | N/A | 2000 ms | Conversational | ES1% |
| | (NOTE 1) | | (NOTEs | | | | Voice | |
| | | | 11, 13) | | | | | |
| 2 | | 40 | 150 ms | 10⁻³ | N/A | 2000 ms | Conversational | ES2% |
| | | | (NOTEs | | | | Video (Live | |
| | | | 11, 13) | | | | Streaming) | |
| 3 | | 30 | 50 ms | 10⁻³ | N/A | 2000 ms | Real Time Gaming, | ES3% |
| | | | (NOTEs | | | | V2X messages (see | |
| | | | 11, 13) | | | | TS 23.287 [121]). | |
| | | | | | | | Electricity | |
| | | | | | | | distribution - | |
| | | | | | | | medium voltage, | |
| | | | | | | | Process automation | |
| | | | | | | | monitoring | |
| 4 | | 50 | 300 ms | 10⁻⁶ | N/A | 2000 ms | Non- | ES4% |
| | | | (NOTEs | | | | Conversational | |
| | | | 11, 13) | | | | Video (Buffered | |
| | | | | | | | Streaming) | |
| . | | . | . | . | . | . | . | . |
| . | | . | . | . | . | . | . | . |
| . | | . | . | . | . | . | . | . |

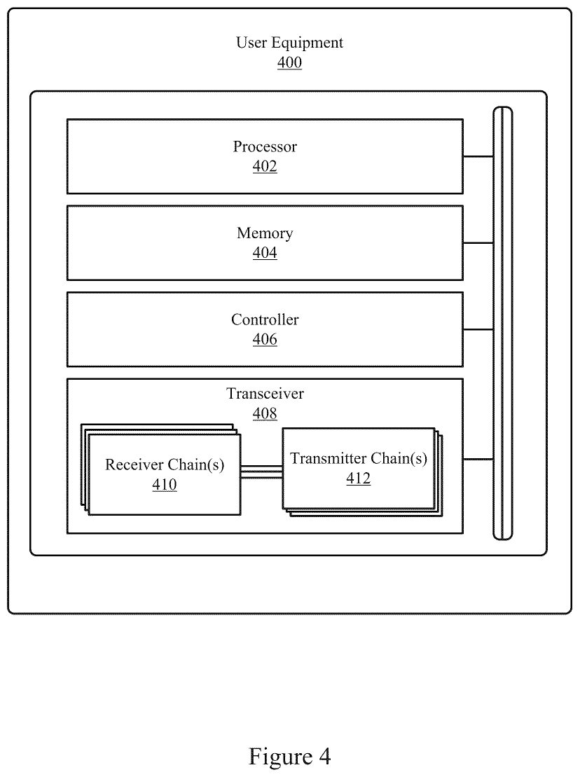

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving, from a NE, an indication of an NES class, the NES class including a QCI supported by the NE, the indication of the NES class being signaled as at least one of: a SIB that includes an NES configuration of the NES class, or as a RRC signaling that includes the NES configuration; or the SIB that indicates the NES class and a network capability information as the RRC signaling that includes the NES configuration; and configuring the UE based on at least one of the NES configuration or the NES class.

Additionally, the UE 400 may be configured to support any one or combination of an admission of a UE connection to the NE is based at least in part on an energy saving requirement associated with the NES class. An admission of a UE connection to the NE is based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

Additionally, or alternatively, the UE 400 may support at least one memory and at least one processor coupled with the at least one memory and configured to cause the UE to: receive, from a NE, an indication of an NES class, the NES class including a QCI supported by the NE, the indication of the NES class being signaled as at least one of: a SIB that includes an NES configuration of the NES class, or as a RRC signaling that includes the NES configuration; or the SIB that indicates the NES class and a network capability information as the RRC signaling that includes the NES configuration; and configure the UE based on at least one of the NES configuration or the NES class.

Additionally, the UE 400 may be configured to support any one or combination of an admission of a UE connection to the NE is based at least in part on an energy saving requirement associated with the NES class. An admission of a UE connection to the NE is based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

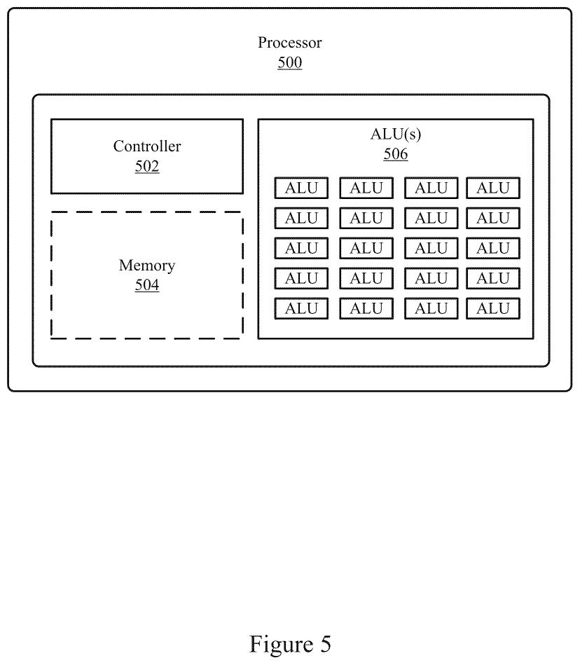

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller coupled with at least one memory and configured to cause the processor to: receive, from a NE, an indication of an NES class, the NES class including a QCI supported by the NE, the indication of the NES class being signaled as at least one of: a SIB that includes an NES configuration of the NES class, or as a RRC signaling that includes the NES configuration; or the SIB that indicates the NES class and a network capability information as the RRC signaling that includes the NES configuration; and configure a UE based on at least one of the NES configuration or the NES class.

Additionally, the processor 500 may be configured to or operable to support any one or combination of an admission of a UE connection to the NE is based at least in part on an energy saving requirement associated with the NES class. An admission of a UE connection to the NE is based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

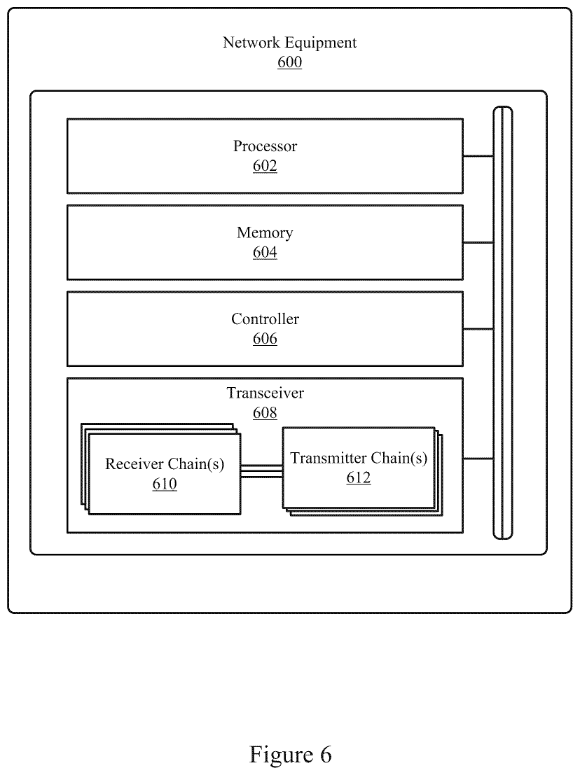

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for configuring the NE in at least one NES mode based on an NES class and an NES configuration, the NES class and the NES configuration obtained by at least one of: determining the NES class and the NES configuration at the NE; receiving the NES class and the NES configuration as provisioned by a network management entity; determining the NES configuration at the NE based at least in part on receiving the NES class as provisioned by the network management entity; or receiving the NES class and the NES configuration from a network entity.

Additionally, the NE 600 may be configured to or operable to support any one or combination of the network management entity is core network or an orchestration management entity that provisions at least one of the NES class or the NES configuration. The method further comprising determining the NES class and the NES configuration at the NE based at least in part on data traffic and a QCI. The method further comprising determining the NES class and the NES configuration at the NE based at least in part on cell load, data traffic, and available QCIs from the data traffic. At least one of the NES class or the NES configuration is determined based at least in part on a set of QCI values in a 5G QCI table, the set of QCI values corresponding to NES solutions for energy savings. At least one of the NES class or the NES configuration is determined based at least in part on a set of QoS energy saving metrics in a 5G QCI table, the set of QoS energy saving metrics corresponding to NES solutions for energy savings. The NES mode is associated with one or more QoS data flows, and wherein an association indicates that the one or more QoS data flows are supported by the NES mode. An admission of a UE connection based at least in part on an energy saving requirement associated with the NES class. An admission of a UE connection based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

Additionally, or alternatively, the NE 600 may support at least one memory and at least one processor coupled with the at least one memory and configured to cause the NE to: configure the NE in at least one NES mode based on an NES class and an NES configuration, the NES class and the NES configuration obtained by at least one of: determine the NES class and the NES configuration at the NE; the NES class and the NES configuration are provisioned by a network management entity; the NES class is provisioned by the network management entity and determine the NES configuration at the NE based at least in part on the NES class; or receive the NES class and the NES configuration from a network entity.

Additionally, the NE 600 may be configured to support any one or combination of the network management entity is core network or an orchestration management entity that provisions at least one of the NES class or the NES configuration. The at least one processor is configured to cause the NE to determine the NES class and the NES configuration at the NE based at least in part on data traffic and a QCI. The at least one processor is configured to cause the NE to determine the NES class and the NES configuration at the NE based at least in part on cell load, data traffic, and available QCIs from the data traffic. At least one of the NES class or the NES configuration is determined based at least in part on a set of QCI values in a 5G QCI table, the set of QCI values corresponding to NES solutions for energy savings. At least one of the NES class or the NES configuration is determined based at least in part on a set of QoS energy saving metrics in a 5G QCI table, the set of QoS energy saving metrics corresponding to NES solutions for energy savings. The NES mode is associated with one or more QoS data flows, and wherein an association indicates that the one or more QoS data flows are supported by the NES mode. An admission of a UE connection is based at least in part on an energy saving requirement associated with the NES class. An admission of a UE connection is based at least in part on an energy saving requirement associated with the NES class and a QoS. Energy savings corresponding to the NES mode is a priority for the admission of the UE connection, and the QoS is negotiable. Energy savings corresponding to the NES mode and the QoS are negotiable for the admission of the UE connection.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

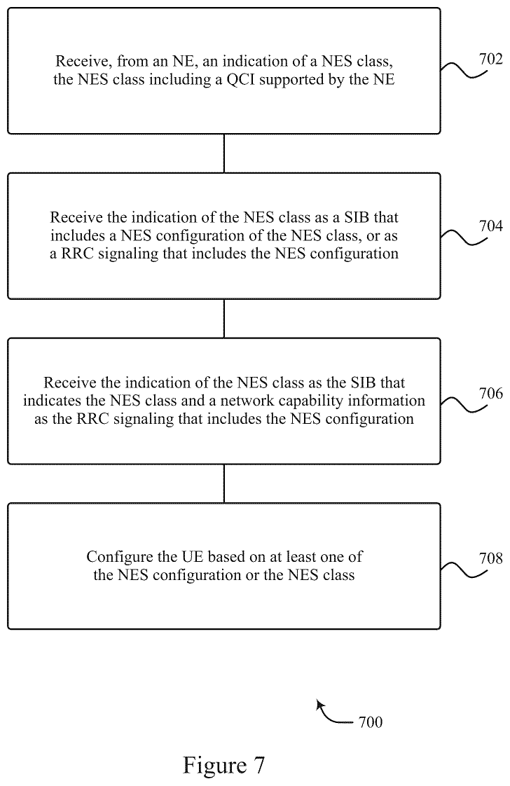

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include receiving, from an NE, an indication of an NES class, the NES class including a QCI supported by the NE. The operations of 702 may be performed in accordance with examples as described herein. In some implementations, aspects of the operations of 702 may be performed by a UE as described with reference to FIG. 4.

At 704, the method may include receiving the indication of the NES class as a SIB that includes an NES configuration of the NES class, or as a RRC signaling that includes the NES configuration. The operations of 704 may be performed in accordance with examples as described herein. In some implementations, aspects of the operations of 704 may be performed by a UE as described with reference to FIG. 4.

At 706, the method may include receiving the indication of the NES class as the SIB that indicates the NES class and a network capability information as the RRC signaling that includes the NES configuration. The operations of 706 may be performed in accordance with examples as described herein. In some implementations, aspects of the operations of 706 may be performed a UE as described with reference to FIG. 4.

At 708, the method may include configuring the UE based on at least one of the NES configuration or the NES class. The operations of 708 may be performed in accordance with examples as described herein. In some implementations, aspects of the operations of 708 may be performed a UE as described with reference to FIG. 4.

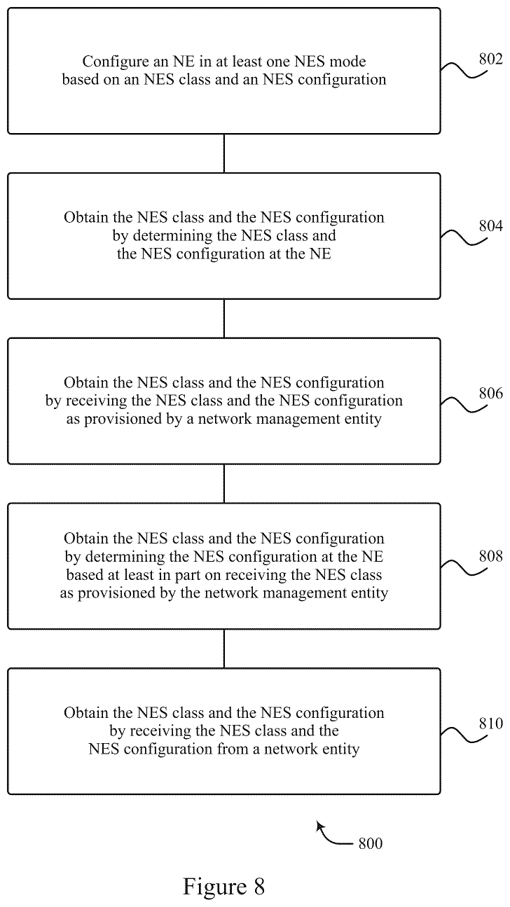

FIG. 8 illustrates a flowchart of a method 800 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include configuring an NE in at least one NES mode based on an NES class and an NES configuration. The operations of 802 may be performed in accordance with examples as described herein. In some implementations, aspects of the operations of 802 may be performed by a NE as described with reference to FIG. 6.

At 804, the method may include obtaining the NES class and the NES configuration by determining the NES class and the NES configuration at the NE. The operations of 804 may be performed in accordance with examples as described herein. In some implementations, aspects of the operations of 804 may be performed by a NE as described with reference to FIG. 6.

At 806, the method may include obtaining the NES class and the NES configuration by receiving the NES class and the NES configuration as provisioned by a network management entity. The operations of 806 may be performed in accordance with examples as described herein. In some implementations, aspects of the operations of 806 may be performed a NE as described with reference to FIG. 6.

At 808, the method may include obtaining the NES class and the NES configuration by determining the NES configuration at the NE based at least in part on receiving the NES class as provisioned by the network management entity. The operations of 808 may be performed in accordance with examples as described herein. In some implementations, aspects of the operations of 808 may be performed a NE as described with reference to FIG. 6.

At 810, the method may include obtaining the NES class and the NES configuration by receiving the NES class and the NES configuration from a network entity. The operations of 810 may be performed in accordance with examples as described herein. In some implementations, aspects of the operations of 810 may be performed a NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network equipment (NE), an indication of a network energy saving (NES) class, the NES class including a quality of service (QoS) class identifier (QCI) supported by the NE, the indication of the NES class being signaled as at least one of:
a system information broadcast (SIB) that includes an NES configuration of the NES class, or as a radio resource control (RRC) signaling that includes the NES configuration; or
the SIB that indicates the NES class and a network capability information as the RRC signaling that includes the NES configuration; and
configure the UE based on at least one of the NES configuration or the NES class.

2. The UE of claim 1, wherein an admission of a UE connection to the NE is based at least in part on an energy saving requirement associated with the NES class.

3. The UE of claim 1, wherein an admission of a UE connection to the NE is based at least in part on an energy saving requirement associated with the NES class and a QoS.

4. The UE of claim 3, wherein energy savings corresponding to an NES mode is a priority for the admission of the UE connection, and the QoS is negotiable.

5. The UE of claim 3, wherein energy savings corresponding to an NES mode and the QoS are negotiable for the admission of the UE connection.

6. A processor for wireless communication, comprising:
at least one controller coupled with at least one memory and configured to cause the processor to:
receive, from a network equipment (NE), an indication of a network energy saving (NES) class, the NES class including a quality of service (QoS) class identifier (QCI) supported by the NE, the indication of the NES class being signaled as at least one of:
a system information broadcast (SIB) that includes an NES configuration of the NES class, or as a radio resource control (RRC) signaling that includes the NES configuration; or
the SIB that indicates the NES class and a network capability information as the RRC signaling that includes the NES configuration; and
configure a user equipment (UE) based on at least one of the NES configuration or the NES class.

7. The processor of claim 6, wherein an admission of a UE connection to the NE is based at least in part on an energy saving requirement associated with the NES class.

8. The processor of claim 6, wherein an admission of a UE connection to the NE is based at least in part on an energy saving requirement associated with the NES class and a QoS.

9. The processor of claim 8, wherein energy savings corresponding to an NES mode is a priority for the admission of the UE connection, and the QoS is negotiable.

10. The processor of claim 8, wherein energy savings corresponding to an NES mode and the QoS are negotiable for the admission of the UE connection.

11. A method performed by a user equipment (UE), the method comprising:
receiving, from a network equipment (NE), an indication of a network energy saving (NES) class, the NES class including a quality of service (QoS) class identifier (QCI) supported by the NE, the indication of the NES class being signaled as at least one of:
a system information broadcast (SIB) that includes an NES configuration of the NES class, or as a radio resource control (RRC) signaling that includes the NES configuration; or
the SIB that indicates the NES class and a network capability information as the RRC signaling that includes the NES configuration; and
configuring the UE based on at least one of the NES configuration or the NES class.

12. The method of claim 11, wherein an admission of a UE connection to the NE is based at least in part on an energy saving requirement associated with the NES class.

13. The method of claim 11, wherein an admission of a UE connection to the NE is based at least in part on an energy saving requirement associated with the NES class and a QoS.

14. The method of claim 13, wherein energy savings corresponding to an NES mode is a priority for the admission of the UE connection, and the QoS is negotiable.

15. The method of claim 13, wherein energy savings corresponding to an NES mode and the QoS are negotiable for the admission of the UE connection.

16. A network equipment (NE) for wireless communication, comprising:
at least one memory; and
at least one processor coupled with the at least one memory and configured to cause the NE to:
configure the NE in at least one network energy saving (NES) mode based on an NES class and an NES configuration, the NES class and the NES configuration obtained by at least one of:
determine the NES class and the NES configuration at the NE;
the NES class and the NES configuration are provisioned by a network management entity;
the NES class is provisioned by the network management entity and determine the NES configuration at the NE based at least in part on the NES class; or
receive the NES class and the NES configuration from a network entity.

17. The NE of claim 16, wherein the network management entity is core network or an orchestration management entity that provisions at least one of the NES class or the NES configuration.

18. The NE of claim 16, wherein the at least one processor is configured to cause the NE to determine the NES class and the NES configuration at the NE based at least in part on one of:
data traffic and a quality of service (QoS) class identifier (QCI); or
cell load, the data traffic, and available quality of service (QoS) class identifiers (QCIs) from the data traffic.

19. The NE of claim 16, wherein at least one of the NES class or the NES configuration is determined based at least in part on a set of quality of service (QoS) class identifier (QCI) values in a 5G QCI table, the set of QCI values corresponding to NES solutions for energy savings.

20. The NE of claim 16, wherein at least one of the NES class or the NES configuration is determined based at least in part on a set of quality of service (QoS) energy saving metrics in a 5G QCI table, the set of QoS energy saving metrics corresponding to NES solutions for energy savings.
